(19) United States
(12) Patent Application Publication
(10) Pub. No.: US 2021/0005170 A1
(43) Pub. Date: Jan. 7, 2021

(54) Wideband Mechanical Amplifier of Frequency Characteristics of Sound of Plucked and Bowed String Musical Instruments

(71) Applicants: Valerii A. MERKULOV, Ulyanovsk (RU); Leonid V. FISKALOV, Ulyanovsk (RU)

(72) Inventors: Valerii A. MERKULOV, Ulyanovsk (RU); Leonid V. FISKALOV, Ulyanovsk (RU)

(21) Appl. No.: 16/891,749

(22) Filed: Jun. 3, 2020

Related U.S. Application Data
(63) Continuation of application No. PCT/RU2019/000145, filed on Mar. 6, 2019.

(30) Foreign Application Priority Data
Mar. 19, 2018 (RU) 2018109627

(51) Int. Cl. G10D 3/02

(52) U.S. Cl. CPC G10D 3/02

(57) ABSTRACT

The invention relates to the design of wideband mechanical amplifiers of the frequency characteristics of the sound of plucked and bowed string instruments. The present device comprises a plate fastened by one end in a base. The free end of the plate can be straight or bent at any angle, or can be configured with a curve of any radius depending on the dimensions of the body of the instrument. The technical result is improved sound quality and density, as well as a broader frequency spectrum.

### RELATED APPLICATIONS

This Application is a Continuation application of International Application PCT/RU2019/000145, filed on Mar. 6, 2019, which in turn claims priority to Russian Patent Application RU2018109627, filed Mar. 19, 2018, both of which are incorporated herein by reference in their entirety.

### FIELD OF THE INVENTION

The claimed invention relates to the design of wideband mechanical amplifiers of sound of plucked and bowed string musical instruments.

### BACKGROUND OF THE INVENTION

The conducted technical level analysis, including searches against patent and sources of scientific and technical information, allowed to establish that the applicant had found no similar invention with signatures specific to the claimed invention's essential features set out in the claims of the invention.

### SUMMARY OF THE INVENTION

The object of the invention is making of the wideband mechanical amplifier of frequency characteristics of sound of plucked and bowed musical instruments to achieve the technical result consisting in improved audio quality, enhanced sound and sustain intensity, sound high-density and frequency spectrum extension.

The technical result is achieved by the fact that the wideband mechanical amplifier of frequency characteristics of sound of plucked and bowed musical instruments has a plate fastened with one end to a base member.

One of the invention's preferred embodiments can have the plate's free end made straight.

The invention's most preferred embodiment can have the plate's free end made curved at any angle.

Furthermore, the plate's free end can have a bend of any radius subject to dimensions of the musical instrument's body.

### BRIEF DESCRIPTION OF THE DRAWINGS

The invention's nature is explained by the attached drawings, outlining a concept of one of possible designs of the claimed device, where

FIG. 1 shows provided device;

FIG. 2 shows possible alternative designs of the plate;

FIG. 3A shows front soundboard of acoustic guitar;

FIG. 3B shows rear soundboard of acoustic guitar,

FIG. 4A shows front soundboard of acoustic bow instrument;

FIG. 4B shows rear soundboard of acoustic instrument.

### DETAILED DESCRIPTION OF THE PREFERRED EMBODIMENTS

The drawings' dotted line shows the preferred partitioning area of the wideband mechanical amplifier of area of frequency characteristics of sound in a musical instrument.

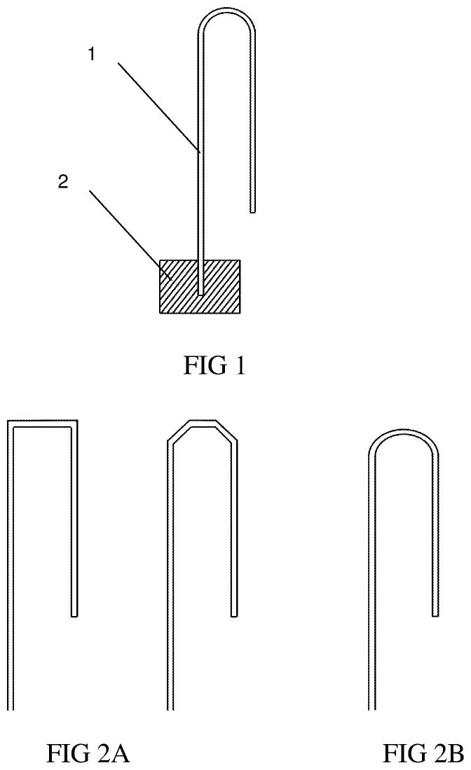

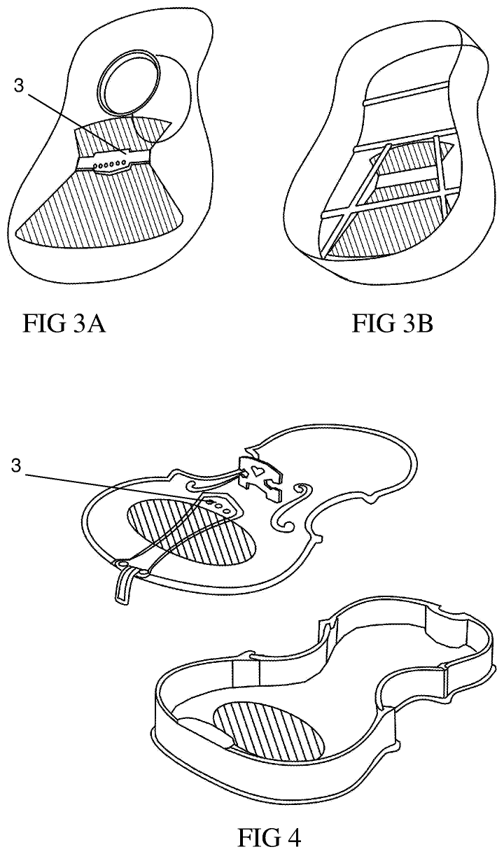

The present device comprises the plate (FIG. 1), fastened with one end to the base 2. The plate's free end can be made straight or bent at any angle (FIG. 2a), or, alternatively, made with a curve of any radius (FIG. 26) subject to dimensions of the musical instrument's body. The device is installed mainly in the bridge area of electric and semi-acoustic guitars in presence of cavities, as well as in acoustic musical instruments—in the area of the string support plate 3, (FIGS. 3 and 4).

The present device can be installed on any surfaces (side wall, front and rear soundboards) of a musical instrument's cavities omnidirectionally at any angle. The present device, installed in musical instruments, can vary in number while free ends of the plate 1 must neither be tangent to the instrument's body nor to each other.

During playing the musical instrument, the wideband mechanical amplifier of sound frequency characteristics amplifies resonance frequency characteristics inducing appearance of additional partials of sound coloring. The sound quality attains a new level while the sound level will increase even more on acoustical instruments.

What is claimed is:

1. A wideband mechanical amplifier of frequency characteristics of sound of plucked and bowed string musical instruments:
the amplifier comprising a base member disposed in an cavity of a musical instrument, the base member being arranged omnidirectionally at any angle on any surface of the internal cavity; and
a plate having a first end fastened to the base member, and a second end not being in contact with a body of the musical instrument.

2. The amplifier of claim 1, wherein the second end of the plate made straight.

3. The amplifier of claim 1, wherein the second end of the plate is bent at any angle.

4. The amplifier of claim 1, wherein the second end of the plate is curved at any radius depending on dimensions of the body of the musical instrument.
